(19) United States
(12) Patent Application Publication
(10) Pub. No.: US 2008/0157934 A1
(43) Pub. Date: Jul. 3, 2008

(54) High priority RFID tags system and method

(76) Inventor: Joshua Posamentier, Oakland, CA (US)

Correspondence Address: INTEL CORPORATION;c/o INTELLEVATE, LLC, P.O. BOX 52050, MINNEAPOLIS, MN, 55402, US

(21) Appl. No.: 11/647,102

(22) Filed: Dec. 27, 2006

(51) Int. Cl. H04Q 5/22

(52) U.S. Cl. 340/10.42

(57) ABSTRACT

According to some embodiments, RFID tags may be assigned a priority level. RFID tags with higher priority levels may respond multiple times to a single interrogation signal. Further, a data-rich RFID tag may response multiple times to a single interrogation signal but with differing payloads. Further, an RFID tag may identify an unused slot and provide a response prior to the end of the slot.

### BACKGROUND

### Description of the Related Art

Radio Frequency Identification (RFID) technology is well known. An RFID tag may be an integrated circuit embedded within a tag insert or an inlay including an integrated circuit attached to an antenna. An RFID reader/writer sends out electromagnetic waves to an RFID tag that induces a current or voltage in the tag's antenna. The RFID reader/writer may be a fixed device or a portable device. The tag modulates the waves and may send information back to the RFID reader/writer. Additional information about the items the tag is attached to can be stored in the tag. The tag may be passive or active. Passive RFID tags typically have no stored power source such as a local battery, and rely upon the energy delivered by the interrogation signal to transit a stream of information. Active RFID tags may have a power source such as a battery or ultracapacitor. Information may be exchanged between the tag and the RFID reader/writer through either inductive coupling or electromagnetic wave backscattering. RFID systems may use many different frequencies, but generally the most common are low frequency (around 125 KHz), high frequency (13.56 MHz), ultra-high frequency (850-900 MHz), and microwave (2.45 Ghz).

RFID systems may be utilized to determine the current location of articles of interest, inventory control and tracking, asset tracking and recovery, tracking manufacturing parts, tracking goods in supply chains, payment systems, and the like. An RFID tag may store information that may be used for security, access control, and/or authentication purposes.

In some environments, reading a particular tag or group of tags may be difficult due to the density of tags. For example, in a warehouse environment, there may be multiple products with RFID tags in a carton and multiple cartons with RFID tags on a pallet. The pallet may also have an RFID tag. A reading in the vicinity of the pallet will produce multiple colliding responses from the products, cartons and the pallet. Multiple pallets in close proximity compound the likelihood of response collisions.

A framed slotted Aloha algorithm has been proposed where responses from multiple devices to a single interrogation signal are spread amongst several slots of a frame. According to the slotted aloha base protocol ISO18000-6C, a parameter called Q is used to calculate the number of available response slots (2̂Q) to a single interrogation signal. ISO18000-6C compliant tags have a random number generator that enables them to respond in a single time slot. Each tag responds to a random slot in the frame, thus distributing the responses and reducing the number of collisions. By repeatedly interrogating the unread tags, eventually all tags can be read.

As environments become more tag dense, use of the Aloha protocol becomes prohibitive due to the multiple reads to obtain a desired tag reading. Further, as RFID devices become more data-rich, reading a tag may take a significant amount of time to read. For example, reading 1 k of data with C1G2 protocol would fill over 11 standard 96 bit tag payloads. More efficient techniques are needed to read tag information in tag dense and/or data-rich environments.

### DESCRIPTION OF THE DRAWINGS

The present invention may be better understood, and its numerous features and advantages made apparent to those skilled in the art by referencing the accompanying drawings.

FIG. 1 illustrates an RFID system according to an embodiment of the present invention.

FIG. 2 illustrates RFID tag responses to a single interrogation signal according to an embodiment of the present invention.

FIG. 3 illustrates a flow diagram for an RFID high priority tag according to an embodiment of the present invention.

FIG. 4 illustrates a flow diagram for an RFID reader/writer according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, state machine and the like that manipulate and/or transform data represented as physical, such as electronic, quantities into other data similarly represented as physical quantities.

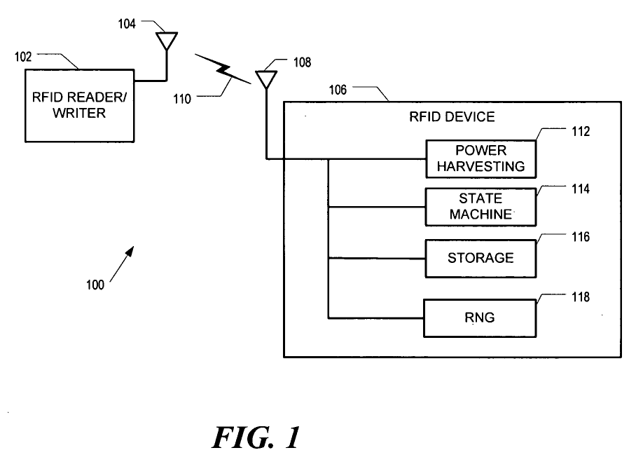

FIG. 1 illustrates an RFID system according to an embodiment of the present invention. System 100 includes a radio frequency identification (RFID) reader/writer 102 having antenna 104 and an RFID device 106 having antenna 108. Any of a number of different low profile antenna types may be used for RFID antenna 104 and RFID antenna 106 including, for example, a dipole, a loop, a patch, and/or others.

To access RFID device 106, an interrogation signal 110 may be transmitted by RFID reader 102 in a vicinity of RFID device 106. RFID device 106 receives and processes an RF signal 10 from RFID reader/writer 102. RFID device 106 may include power harvesting and voltage processing circuitry 112, a processor or state machine 114, storage 116, and a random number generator 118. Power harvesting and voltage processing circuitry 112 may include protection circuitry such as a diode (not shown) and a voltage regulator (not shown) and an inductor (not shown) to receive RF signal 110 and charge one or more capacitors (not shown) to generate power to operate RFID device 106, although the invention is not limited in this context. Storage 116 may include non-volatile re-writable memory, although the invention is not limited in this context. Storage 116 may also contain a key for decryption, a device identification for signal authentication, and other such information. Random number generator 118 is used to determine in which slot(s) the RFID device 106 responds. In alternate embodiments of the invention alternate techniques may be used to determine in which slot(s) the RFID device 106 responds.

Although only one RFID device 106 is shown in FIG. 1, multiple RFID devices 106 may be within read range of RF signal 110. According to an embodiment of the present invention, different RFID tags have different priorities assigned to them. For example, a pallet of product may have a pallet tag, carton tags, and item level tags. In some scenarios such as driving quickly through a dock door with this pallet on a forklift, the priority is to read the pallet tag first, then the carton tags, and then the item level tags. Without assigning a priority to the different tags, all tags would have an equal likelihood of being read in a reader-talk-first slotted aloha system.

According to an embodiment of the present invention, RFID tags may be configurable either at the factory or by users with a specific priority level which determines the number of responses in a given frame. A high priority tag may respond multiple times to a single interrogation signal, either providing the same data or different data with each response. In this way, a high priority or data-rich tag can have much higher probability of responding to the reader and being read in a timely manner than a standard tag.

According to another embodiment of the present invention, a RFID tag may listen for tag responses in Q slots, and if it doesn't detect a response just before the end of the timeslot, it could scavenge them at the last second for its own data transfer purposes.

In one embodiment, the RF signal 110 includes enough power such that the RFID device 106 can process the signal, and send a status message back to the RFID reader/writer. In an alternate embodiment, the RFID device includes its own power source. The RF signal may include device identification, authentication information and may be encrypted.

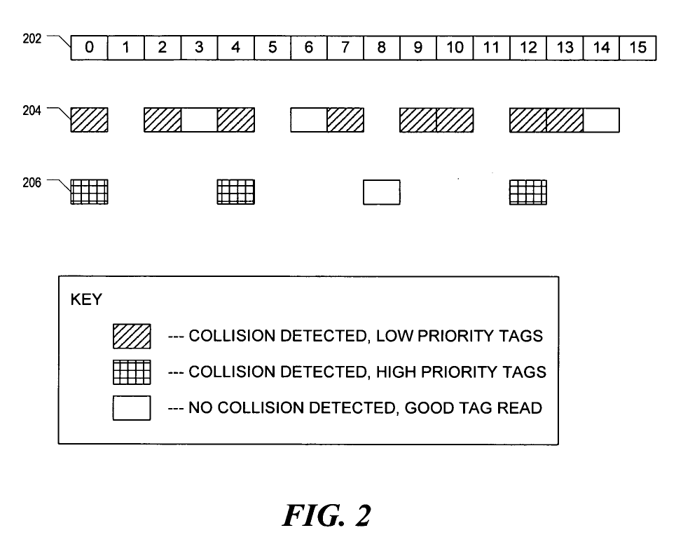

FIG. 2 illustrates RFID tag responses to a single interrogation signal according to an embodiment of the present invention. The given environment includes multiple general tags and a high priority tag with a Q=4, such that there are 16 time slots 202 available for tag responses. General tag responses 204 are shown with multiple tag collisions and multiple good tag reads, distributed amongst the 16 time slots. Each general tag responds to 1 out of the 16 slots. The high priority tag responses 206 illustrate the high priority tag responding multiple times amongst the 16 time slots with multiple tag collisions (collisions with the general tag responses) and a good tag read in time slot 8. The reader will have to send multiple interrogation signals to read all of the general tags, but because the high priority tags responds multiple times in a frame, a good tag read of the higher priority tag has a higher probability within a first interrogation.

Although high priority tag responses 206 are illustrated as periodic in FIG. 2, there is no limitation on the uniformity of the responses. For example, high priority tag responses 206 may occur randomly, for example, in slots 2, 3, 6 and 10. The invention is not limited in this regard.

The environment of the system illustrated in FIG. 2 has multiple general tags with a single high priority tag. According to embodiments of the present invention, the number and types of tags are not limited in this regard. For example, multiple high priority tags may be present. Further, the high priority tags may have differing priority levels, for example, one tag may respond with a higher multiplicity than another tag, for example eight responses versus four responses to a single interrogation signal.

To read all of the tags, the reader may have to provide multiple interrogation signals. In one embodiment of the present invention a tag that has been successfully read is notified and does not respond to subsequent interrogation signals. Further, a data-rich tag that has multiple payloads may respond with only those payloads that have not been successfully read.

Note that a high priority tag may respond multiple times to a single interrogation signal. Some tags may respond with the same data each time. Data-rich tags may respond with different data in each response. The invention is not limited in this respect.

According to embodiments of the present invention, RFID tags may be configured as high priority tags so that critical tags may be read as early as possible (before low priority tags). It addresses one of the issues with an equal priority set of tags without requiring foreknowledge of what types of tags are coming.

According to embodiments of the present invention, RFID tags of sensor applications may report data much faster than otherwise possible, allowing multiple payloads to be read in a shorter period of time.

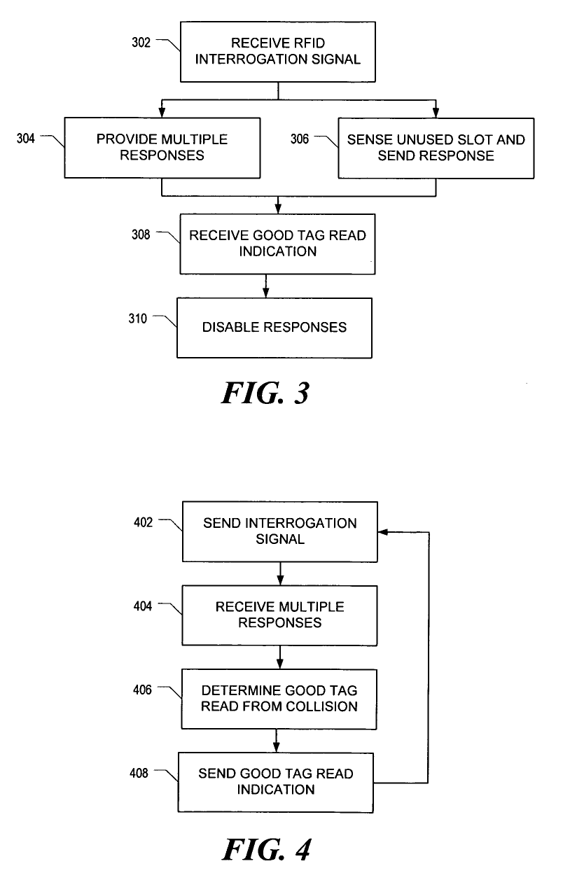

FIG. 3 illustrates a flow diagram for an RFID high priority tag according to an embodiment of the present invention. An RFID tag receives an RFID interrogation signal, block 302. The RFID tag provides multiple responses to the single interrogation signal, block 304. For example, the tag may provide the same response multiple times or provide multiple responses each with a different payload. Alternately or additionally, the RFID tag may sense an unused slot and provide a response prior to the end of the slot, block 306. If the response was received without collisions from other tags, a good tag read indication may be received, block 308. The tag may disable responses, block 310. If the tag has multiple payloads, it may only disable responses for a specific payload that received a good tag read indication.

FIG. 4 illustrates a flow diagram for an RFID reader/writer according to an embodiment of the present invention. An RFID reader may send an interrogation signal, block 402. The RFID reader may receive multiple responses in multiple time slots, block 404. The RFID reader determines good tag reads from collisions, parsing as well multiple responses from a single RFID tag, block 406. The RFID reader may send a good tag read indication, block 408. If the RFID reader has not read all tags or received all payloads from data-rich tags, it may resend an interrogation signal, block 402.

Although discussed above with reference to RFID like systems, other types of wireless communication systems are intended to be within the scope of the present invention including, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect. In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A system comprising:
an antenna; and
a radio frequency identification (RFID) tag configured to provide multiple responses to a single interrogation signal.

2. The system as recited in claim 1, wherein the multiple responses contain a same data payload.

3. The system as recited in claim 1, wherein the multiple responses contain different data payloads.

4. The system as recited in claim 1, wherein the RFID tag includes a random number generator to determine when each of the multiple responses is provided.

5. The system as recited in claim 1, wherein the multiple responses are provided in response slots, wherein the number of response slots is according to an assigned priority of the RFID tag.

6. The system as recited in claim 1, wherein the RFID tag is further configured to sense an unused slot and provide a response before the end of the slot.

7. The system as recited in claim 1, wherein the RFID tag is further configured to not provide a response if a tag read signal is received.

8. A method comprising:
receiving a radio frequency (RF) interrogation signal; and
providing multiple responses to the RF interrogation signal.

9. The method as recited in claim 8, wherein the multiple responses contain a same data payload.

10. The method as recited in claim 8, wherein the multiple responses contain different data payloads.

11. The method as recited in claim 8, further comprising determining when each of the multiple responses is to be provided using a random number generator.

12. The method as recited in claim 8, wherein the number of multiple responses is according to an assigned priority.

13. The method as recited in claim 8, further comprising sensing an unused slot and providing a response before the end of the slot.

14. A method comprising:
sending an interrogation signal; and
receiving multiple radio frequency identification (RFID) tag responses to the interrogation signal; and
determining a good tag read from a collision;
wherein at least two of the multiple RFID tag responses are from the same RFID tag.

15. The method as recited in claim 14, wherein the at least two of the multiple RFID tag responses contain a same data payload.

16. The method as recited in claim 14, wherein the at least two of the multiple RFID tag responses contain different data payloads.

17. The method as recited in claim 14, wherein the number of the at least two of the multiple RFID tag responses is according to an assigned priority.

18. The method as recited in claim 14, further comprising sending an RF signal to disable responses from RFID tags with good tag responses.
